(19) United States
(12) Patent Application Publication
(10) Pub. No.: US 2014/0319733 A1
(43) Pub. Date: Oct. 30, 2014

(54) CAVITY BLOCKER

(71) Applicant: Husky Injection Molding Systems Ltd., Bolton (CA)

(72) Inventors: Christophe Halter, Selange (BE); Arnold Heinz Mai, Irrel (DE); Rainer Kintzinger, Merzig (DE)

(73) Assignee: Husky Injection Molding Systems Ltd., Bolton (CA)

(21) Appl. No.: 14/354,762

(22) PCT Filed: Oct. 17, 2012
(86) PCT No.: PCT/CA2012/050736

§ 371 Date: Apr. 28, 2014

Related U.S. Application Data
(60) Provisional application No. 61/557,573, filed on Nov. 9, 2011.

(51) Int. Cl. B29C 33/44

(52) U.S. Cl. CPC B29C 33/442
USPC 264/334; 425/556

(57) ABSTRACT

Disclosed herein, amongst other things, is an apparatus for use with a mold that includes a blocker that is configured to selectively block an opening of a cavity defined in a cavity member of the mold after retraction of a core member from the cavity, whereupon with ejection of a molded article from the core member the molded article is directed by the blocker into a transfer device for transfer from the mold.

### TECHNICAL FIELD

Non-Limiting embodiments disclosed herein generally relate to an apparatus for use with an injection mold, and more particularly structure and steps for directing a molded article into a transfer device.

### BACKGROUND OF THE INVENTION

It is well known in the molding art to provide a transfer device to receive and transfer a molded article from an open mold. Such transfer devices may be attached to the end of a robot arm and as such are often referred to as an end-of-arm tool ‘EOAT’. In operation, the robot arm selectively positions the EOAT between a pick and place positions, for handling the molded article from the mold to a location outside of the mold. In the pick position, the EOAT is positioned in between open halves of the mold in between a core member and a cavity member thereof for receiving the molded article from one of them. Alternatively, it is also well known to provide a so-called in-mold transfer device that is characterized in that the tooling of the transfer device (i.e. the movable part of the transfer device that receives the molded article) is movably connected to the mold. In operation the tooling of the in-mold transfer device is generally movable between an inboard position and an outboard position, the inboard position being in between the core and cavity of the mold for receiving the molded article therefrom and the outboard position being somewhere beside the core and cavity which may be within the perimeter of the mold.

An example of an in-mold transfer device may be reference in U.S. Pat. No. 7,351,050 to Vanderploeg et al., published on Apr. 1, 2008. The patent discloses a servo side shuttle apparatus and method for a molding machine includes structure and/or steps whereby a shuttle plate is disposed adjacent at least one of a first mold half and a second mold half of the molding machine. A guidance assembly is coupled to the mold half and guides the shuttle plate linearly across a molding face of the mold half. A drive mechanism is provided to drive the shuttle plate in a linear direction. An operation structure is coupled to the shuttle plate and is configured to perform an operation on a molded article disposed either in the mold cavity or on the mold core. The operation may include removing the molded article from a mold core, applying a label to a mold cavity, and/or closing the lid of a molded article while it is resident on the mold core.

Another example of an in-mold transfer device may be reference in PCT patent application publication 2011/063499 to Halter et al., published on Jun. 3, 2011. The patent application discloses a molded article transfer device for use with the injection mold. The molded article transfer device includes a shuttle that is slidably arranged, in use, within the injection mold. The shuttle defines an aperture, at least in part, that alternately accommodates: (i) a first mold stack arranged therein; and (ii) a first molded article received therein with opening of the first mold stack.

### SUMMARY OF THE INVENTION

A general aspect of the invention is to provide an apparatus for use with a mold that includes a blocker that is configured to selectively block an opening of a cavity defined in a cavity member of the mold after retraction of a core member from the cavity, whereupon with ejection of a molded article from the core member the molded article is directed by the blocker into a transfer device for transfer from the mold.

Another general aspect of the invention is to provide a method of molding. The method includes the steps of: closing relative movement between a cavity member and a core member of a mold to define a molding cavity therebetween; molding a molded article within the molding cavity; opening relative movement between the cavity member and the core member to open the molding cavity, wherein the core member is withdrawn from the cavity member; positioning a blocker to block the opening of a cavity that is defined in the cavity member for directing the molded article into a transfer device with ejection of the molded article from the core member; ejecting the molded article from the core member; transferring the molded article in the transfer device; and positioning the blocker to unblock the opening of the cavity.

These and other aspects and features of non-limiting embodiments will now become apparent to those skilled in the art upon review of the following description of specific non-limiting embodiments of the invention in conjunction with the accompanying drawings.

### BRIEF DESCRIPTION OF THE DRAWINGS

The non-limiting embodiments will be more fully appreciated by reference to the accompanying drawings, in which:

FIGS. 1A-1F depict an operational sequence of a schematic representation of a mold that has been configured in accordance with a non-limiting embodiment of the present invention.

FIGS. 2A-2C depict another operational sequence of the mold in accordance with a non-limiting embodiment of the present invention.

FIG. 3 depicts a schematic representation of a mold that has been configured in accordance with a further non-limiting embodiment of the present invention.

FIG. 4 depicts a schematic representation of a mold that has been configured in accordance with yet another non-limiting embodiment of the present invention.

FIG. 5 depicts a flow chart of a method of molding in accordance with a non-limiting embodiment of the present invention.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EMBODIMENT(S)

Reference will now be made in detail to various non-limiting embodiment(s) of an apparatus for use with a mold and a related process for the use thereof. It should be understood that other non-limiting embodiment(s), modifications and equivalents will be evident to one of ordinary skill in the art in view of the non-limiting embodiment(s) disclosed herein and that these variants should be considered to be within scope of the appended claims.

Furthermore, it will be recognized by one of ordinary skill in the art that certain structural and operational details of the non-limiting embodiment(s) discussed hereafter may be modified or omitted (i.e. non-essential) altogether. In other instances, well known methods, procedures, and components have not been described in detail.

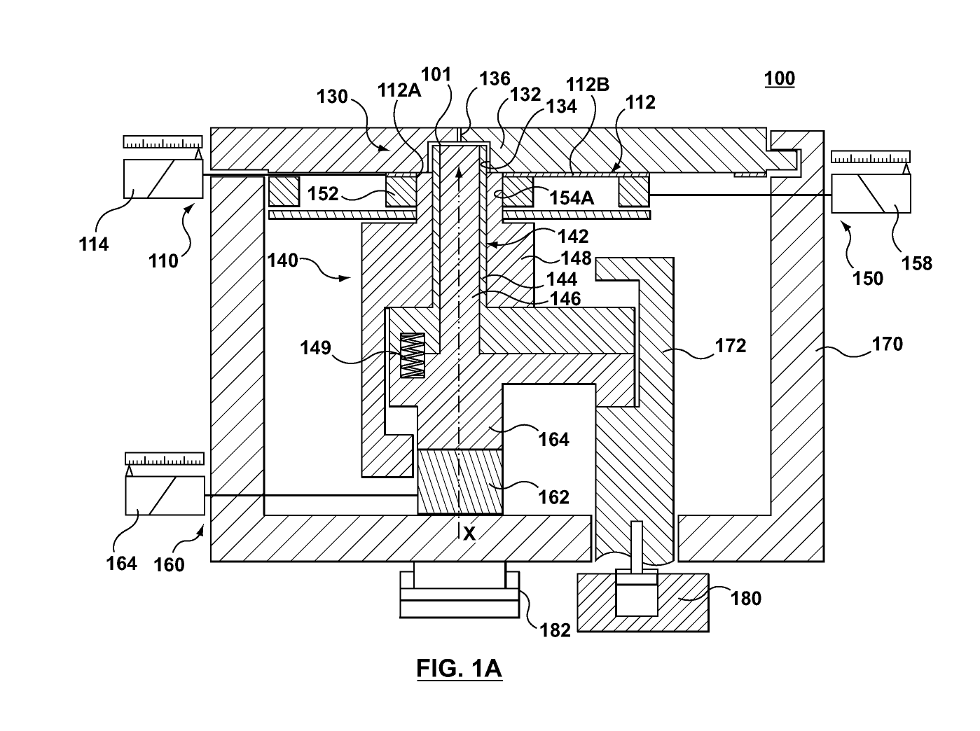

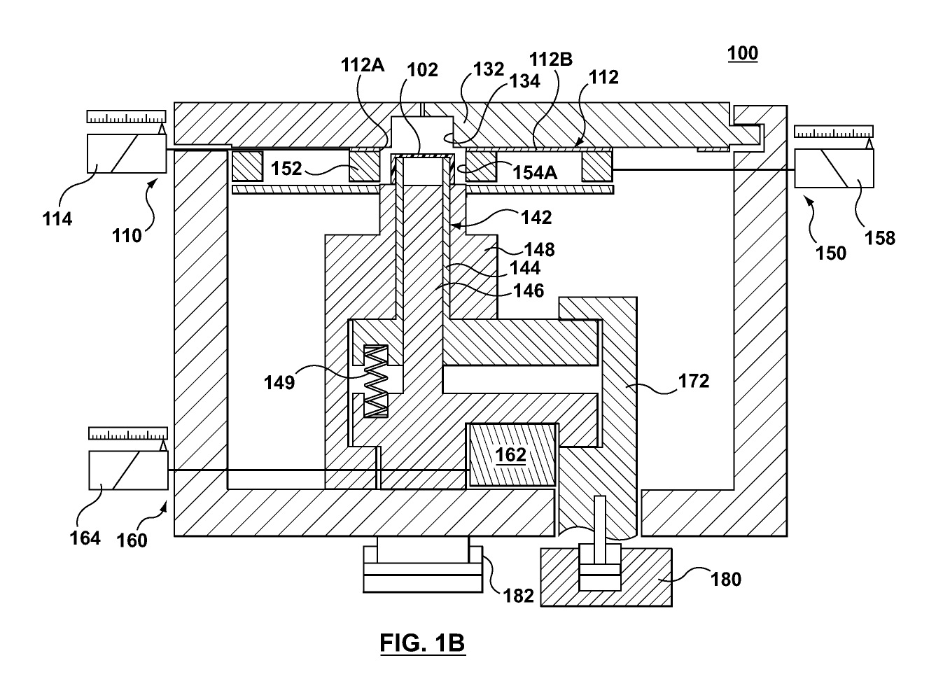

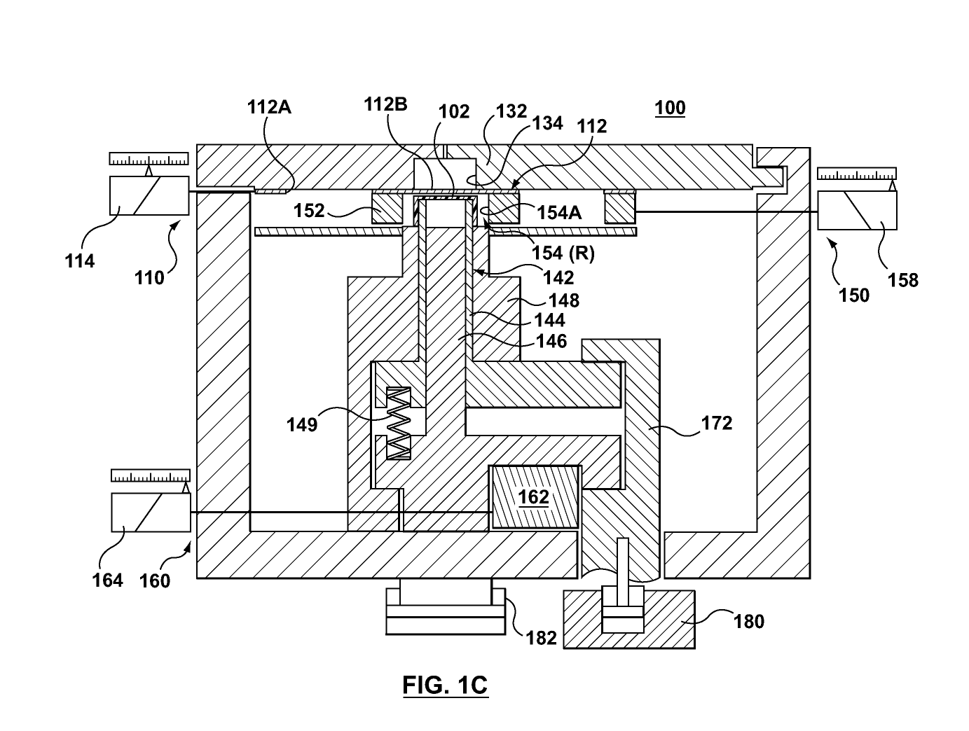

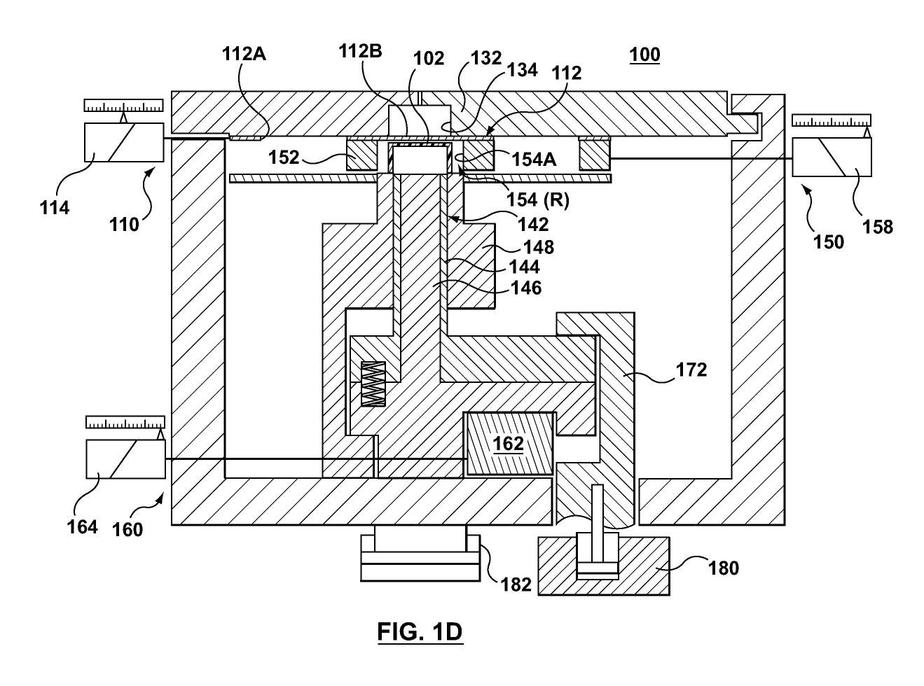

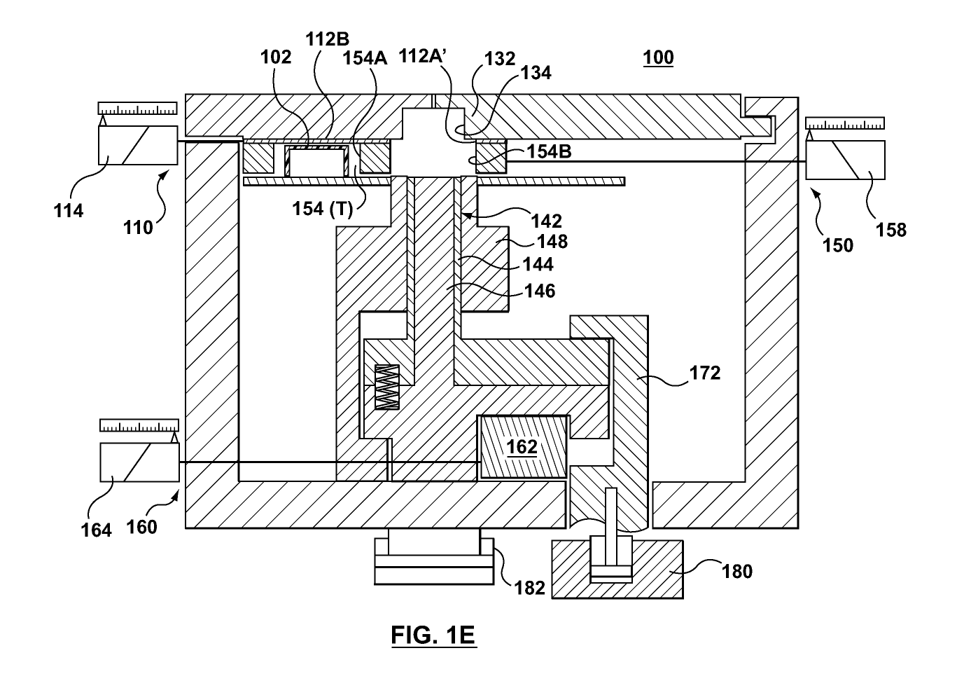

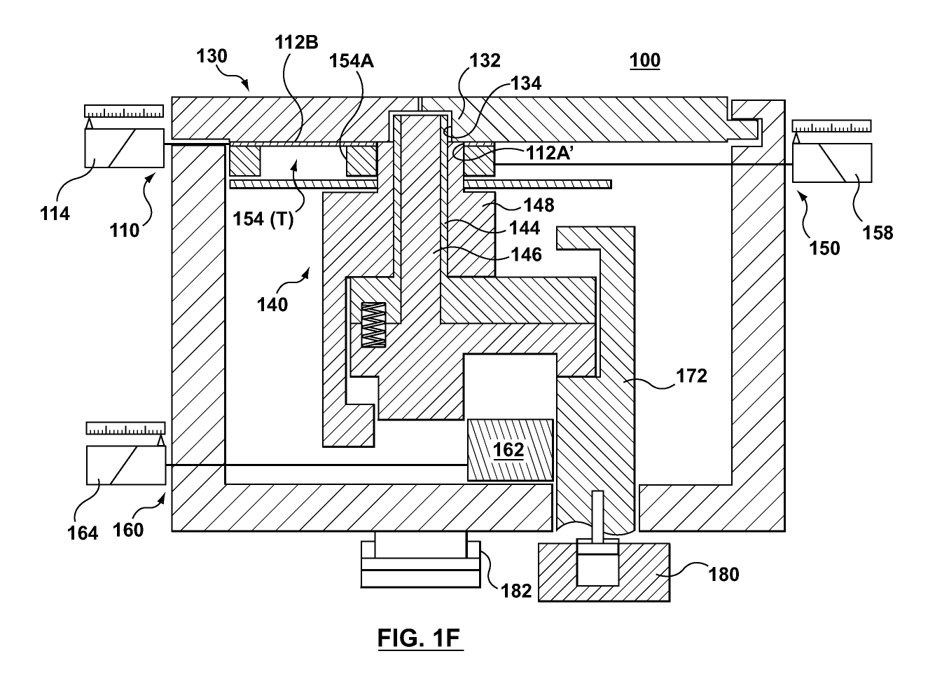

Without limiting the generality of the present invention, in a specific non-limiting embodiment depicted in FIG. 1A the schematic representation of a mold 100 has been configured generally in accordance with the teachings of PCT patent application publication 2011/063499 described previously. That is, the mold 100 broadly includes a first mold half 130, a second mold half 140, a transfer device 150 and a mold shutter 160.

The structure and operation of the first mold half 130 and the second mold half 140 is generally consistent with the prior art and as such will not be described in detail. Suffice it to state that the first mold half 130 includes a cavity member 132 that defines a cavity 134. The cavity 134 defines an outer portion of a molding cavity 101 in cooperation with a stripper sleeve 148 of the second mold half 140. Without specific limitation, in the example shown, the molding cavity 101 has been configured to mold a closure of the type for capping a container (not shown). The cavity member 130 defines a melt passageway 136 for connecting the molding cavity 101 to a melt distribution system (not shown). The second mold half 140 includes a core member 142 and the stripper sleeve 148. The core member 142 defines an inner portion of the molding cavity 101. The stripper sleeve 148 defines a base of the molding cavity 101 and is furthermore configured to eject the molded article from the core member 142 with relative axial motion thereto.

The core member 142 may include, without specific limitation, two parts, namely an outer core 144 and an inner core 146. The core member 142 is made from two parts for sake of releasing an encapsulated portion (e.g. plug seal of the closure—not shown) of the molded article with relative axial motion thereof. A spring 149 or other such biasing means may be arranged between the outer core 144 and the inner core 146 for biasing them apart (i.e. towards a configuration that releases the encapsulated portion of the molded article therefrom.

Broadly speaking, the transfer device 150 includes a shuttle 152 that is laterally movable (i.e. perpendicular to a mold-stroke axis X of the first mold half 130 relative to the second mold half 140 by a transfer actuator 158 in between confronting faces of the first mold half 130 and the second mold half 140. The shuttle 152 defines an aperture 154A (i.e. opening), wherein the aperture 154A is configured to alternately receive: i) the core member 142 positioned therein during molding of the molded article (as shown in FIG. 1A; and ii) the molded article 102 (FIG. 1D) received therein after the ejection thereof from the core member 142.

The mold shutter 160 is operable to selectively engage, in use, the core member 142 to a platen (not shown) of a mold clamping assembly (not shown). The mold shutter 160 includes an ejector box 170 that is mounted, in use, to the platen (not shown). The ejector box 170 is configured to have the first mold half 130 connected to a top surface thereof and to have the second mold half 140 movably arranged therein for movements along the mold-stroke axis X. The movement of the second mold half 140 within the ejector box 170 is provided by an ejector actuator 180 of the mold clamping assembly (not shown) in concert with a link bar 172. The mold shutter 160 also includes a shutter member 162 that is slidably supported on a base of the ejector box 170 for movements between a shut position (FIG. 1A) and an open position (FIG. 1B) by a shutter actuator 164 for selectively engaging a link member 164 that is associated with the core member 142. The shutter member 162 and the link member 164 are selectively engageable (contrast FIGS. 1A and 1B) to hold the second mold half 140 in an extended position, along the mold-stroke axis X, during a step of molding of the molded article (FIG. 1A) and are selectively disengageable to allow for the retraction of the second mold half 140 during a step of ejection of the molded article 102 from the mold core (FIG. 1B).

The mold 100 also includes a blocker 110 in accordance with a non-limiting embodiment of the present invention. The blocker 110 is configured to selectively block an opening of the cavity 134 defined in the cavity member 132 after retraction of the core member 142 from the cavity 134 (FIG. 1C), whereupon with ejection of a molded article 102 from the core member 142 (FIG. 1D), the molded article 102 is directed by the blocker 110 into a receptacle 154 of the transfer device 150. A technical effect of the foregoing is to ensure that the molded article 102 is directed into the receptacle 154 with the ejection thereof from the core member 142 without re-entering the cavity 134.

More specifically, the blocker 110 includes a blade 112 (i.e. thin flat member) that is slidably arranged between the first mold half 130 and the transfer device 150. The blade 112 defines an open portion 112A and a blocking portion 112B that are alternately positionable over the opening in the cavity 134 with repositioning of the blade 112 by a blocker actuator 114 between an unblocked position (FIG. 1A) and a blocked position (FIG. 1C), respectively. It does not matter whether the blocking portion 112B is configured to entirely cover the opening of the cavity 134 or that it be configured to only partly cover the opening of the cavity 134, the important aspect being that it should cover the cavity 134 sufficiently to direct the molded article 102 into the receptacle 102 of the transfer device without re-entering the cavity 134.

It may be appreciated by contrasting the sequence of mold operations in FIGS. 1B, 1C and 1D that the blocker 110 is selectively positionable to arrange the blocking portion 112B thereof in between the cavity member 132 and a receptacle 154 of the transfer device 150 upon retraction of the core member 142 from the cavity 134. The receptacle 154 includes the aperture 154A as well as a front face of the blocker 110. In so doing, the blocker 110 is positioned to direct the molded article 102 to remain in the aperture 154A with ejection thereof (FIG. 1D) from the core member 142 without re-entering the cavity 134 where it could otherwise become stuck. That is, with ejection from the outer core member 142 the molded article 102 may be imparted with energy in the form of random movement which may be, in some cases, towards the cavity 134. Were it not for blocker 110 directing the molded article 102 to remain in the receptacle 154 it could potentially re-enter the cavity 134, at least in part, where it could become stuck and potentially interfere with the operation of the transfer shuttle 150 amongst other things.

It may be appreciated by contrasting the sequence of mold operations in FIGS. 1D and 1E that the blocker 110 is furthermore movable with the shuttle 152 from a receiving position R (FIG. 1D) to a transfer position T (FIG. 1E) so as to continue to define a portion of the receptacle 154 throughout a movement therebetween.

The operational sequence of the mold 100 will now be reviewed. Starting at FIG. 1A, it may be appreciated that the sequence begins with the mold 100 arranged in a closed and clamped configuration (i.e. clamped by a clamp actuator 182 of the mold clamping assembly) and with the molding of a molded article within the molding cavity 101. During the step of molding, the open portion 112A of the blade 112 is arranged over the opening of the cavity 134 and the open portion 112A accommodates the core member 142 arranged therethrough. The next step in the sequence is shown in FIG. 1B, wherein with the completion of the step of molding the molded article 102, the mold 100 is rearranged to position the molded article 102 in the aperture 154A of the transfer device 150. More specifically, the clamp actuator 182 is first disengaged, then the shutter member 162 of the mold shutter 160 is slid by the shutter actuator 160 into an open position such that the ejector actuator 180 is able to retract the second mold half 140 and in so doing retract the core member 142 from the cavity 134. In this configuration it may also be appreciated that inner core 146 is provided with freedom to retract relative to the outer core 144 under the influence of the spring 149 so as to complete an initial step of ejection of the molded article 102 from the core member 142 and in particular to release the encapsulated portion (not shown) of the molded article 102 that is formable therebetween. In the next step, as shown with reference to FIG. 1C, the blocker 110 is re-positioned by the blocker actuator 114 to position the blocking portion 112B of the blade 112 to block the opening of the cavity 134. With reference to FIG. 1D, the next step in the sequence is to complete the ejection of the molded article 102 from the core member 142 wherein the blocker 110 directs the molded article 102 into the receptacle 154 of the transfer device 150 without re-entering the cavity 134. The completion of the step of ejection involves retracting, with the ejector actuator 180, the outer core 144 relative to the inner core 146 and the stripper sleeve 148. In the next step, as shown with reference to FIG. 1E, the molded article 102 is transferred in the receptacle 154 with coordinated movement of the shuttle 152 and the blade 112 from the receiving position R (FIG. 1D) to a transfer position T (FIG. 1E), and in so doing also position another open portion 112A′ of the blade 112 in registration with the cavity 134 to unblock the opening thereof. With reference to FIG. 1F, the sequence ends with closing relative movement between the second mold half 140 and the first mold half 130 and then movement of the shutter member 162 of the mold shutter 160 into a closed position (not shown), whereupon the sequence repeats.

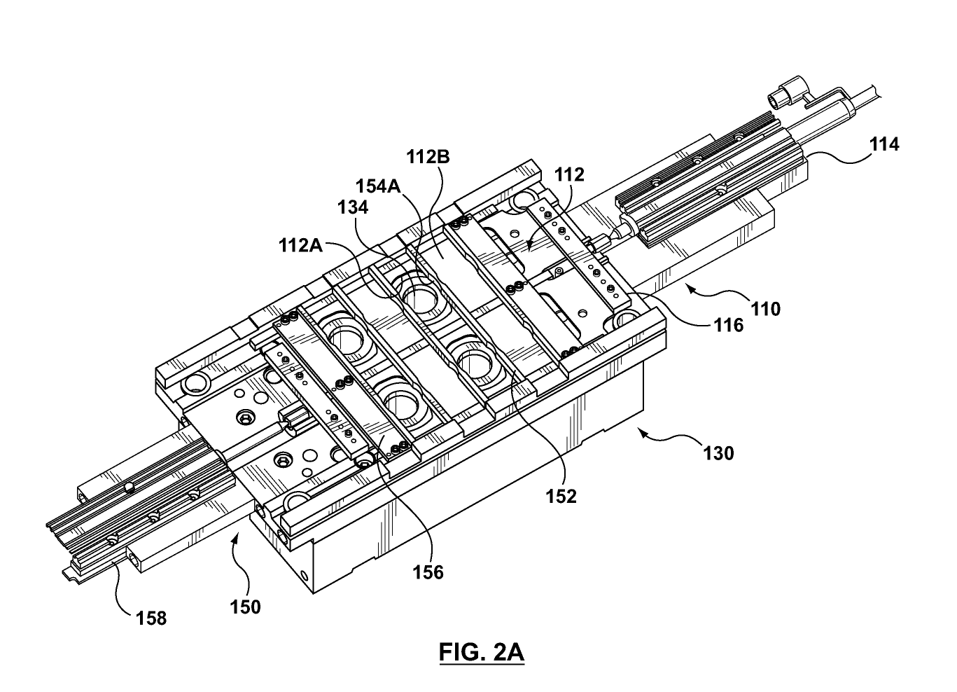

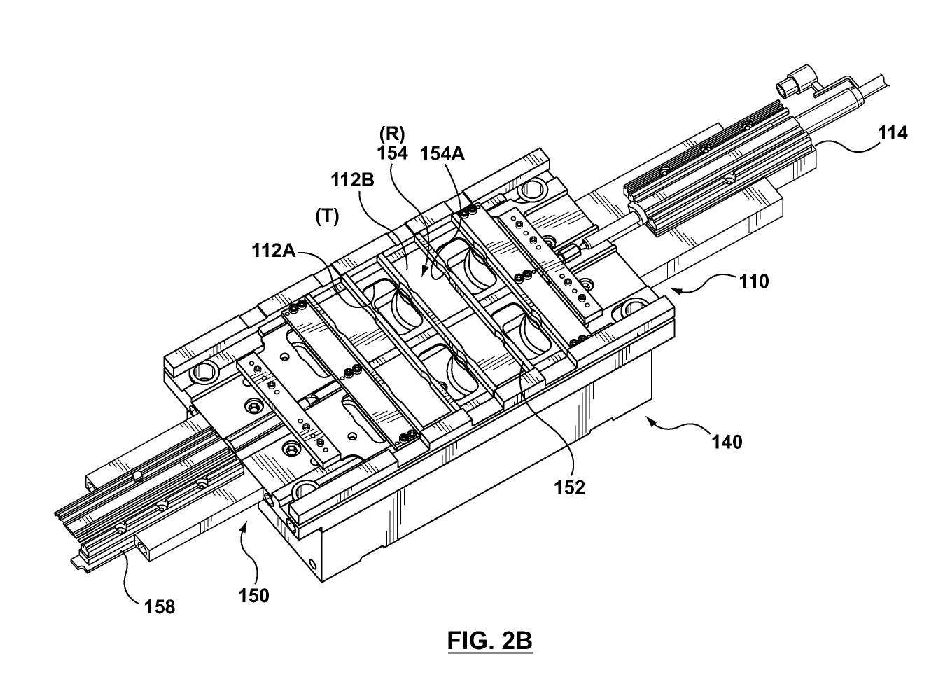

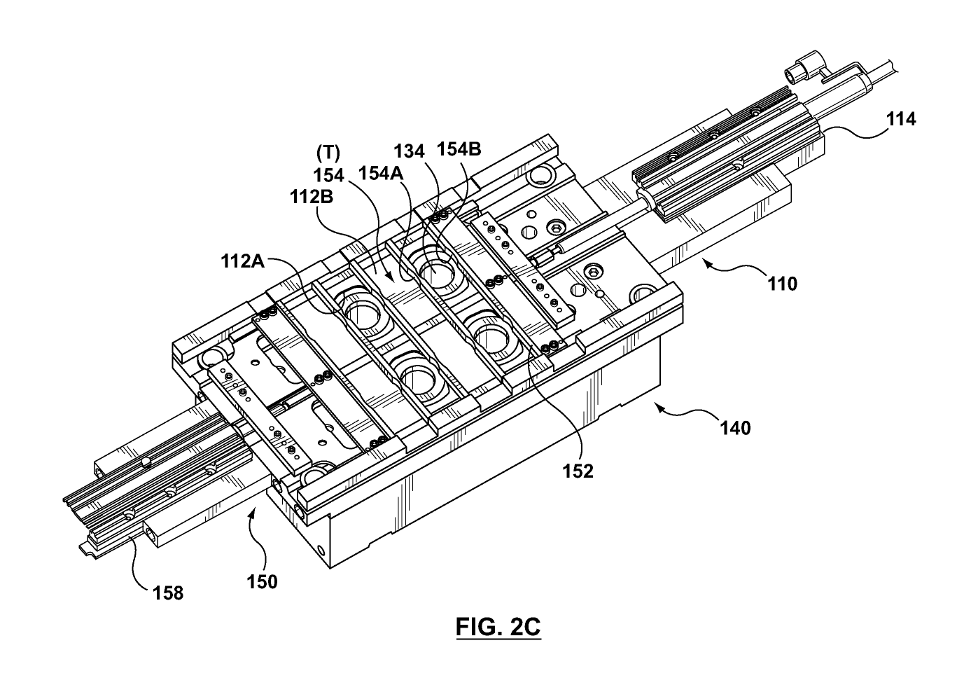

Brief reference shall now be made to FIGS. 2A to 2C which again depicts key aspects of the operational sequence of the mold 100 such that certain structural details thereof may be better appreciated. In particular, the views each depict non-limiting structural embodiments of the first mold half 130, the transfer device 150 and the blocker 110.

From these views it may be appreciated that the blade 112 of the blocker 110 is a thin planar member that is slidably arranged between the transfer device 150 and the first mold half 130. The blade 112 is connected to the blocker actuator 114 through one of a pair of connecting bars 116 that are mounted to the transfer device 150. The blade 112 defines a plurality of open portions, included in which is the open portion 112A, and a plurality of blocking portions included in which is the blocking portion 112B. It may also be appreciated that the shuttle 152 of the transfer device 150 includes a series of parallel rails that together define, in pairs thereof, a plurality of apertures included in which is the aperture 154A. The shuttle 152 is connected to the shuttle actuator 158 through one of a pair of connecting bars 156 that are mounted to the transfer device 150.

By contrasting FIGS. 2A and 2B it may be appreciated that in a first step of transfer, the plurality of blocking portions are positioned over the cavity 134, with sliding movement of the blocker 112, as the shuttle 152 remains stationary. At this point in the sequence the molded article (not shown) is to be ejected from the core member (not shown) and directed into the aperture 154A by the blocking portion 112B of the blade 112. Next, as may be appreciated by contrasting FIGS. 2B and FIG. 2C, the blade 112 and the shuttle 152 are moved together so that the receptacle 154 that is defined therebetween may be moved from the receiving position R (FIG. 2B) to the transfer position T (FIG. 2C). Once in the transfer position T, the molded article (not shown) is directed by means of gravity or air flow to slide in a chute that is defined between the rails of the shuttle 152 towards an exit of transfer device 150.

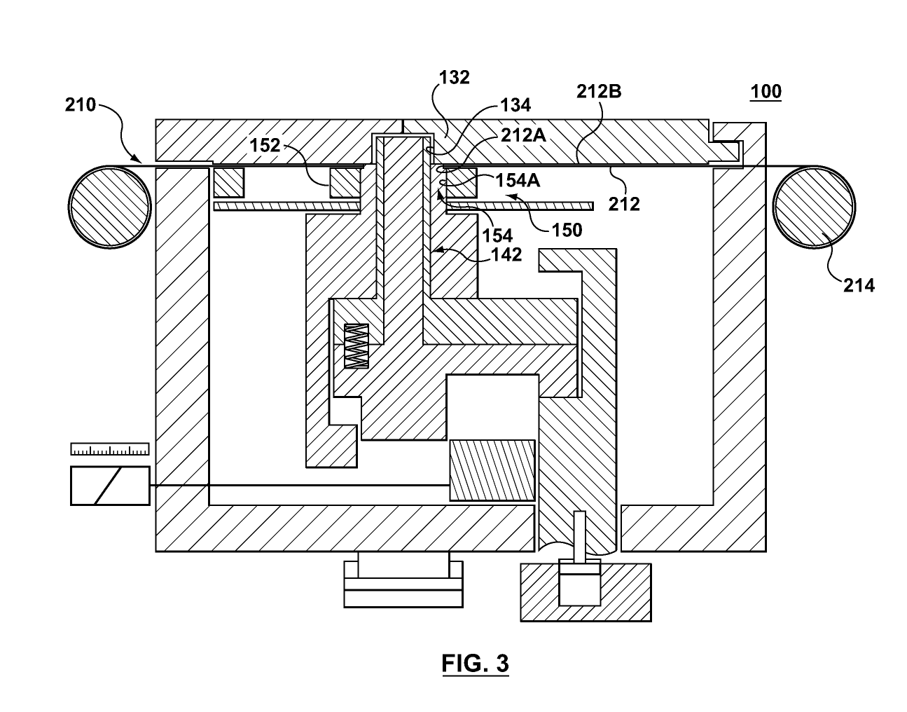

Reference shall now be made to FIG. 3, wherein there is depicted another non-limiting embodiment of the blocker 210 arranged in the mold 100. The blocker 210 comprises a belt of flexible material 212 that, like the blade 112, defines an open portion 212A and a blocking portion 212B. The belt of flexible material 212 is arranged on reels 214, wherein the reels 214 are rotatable by an actuator (not shown) for positioning of the belt of flexible material 212 relative to the cavity member 132. The positioning of the blocker 210 to block the opening of the cavity 134 includes positioning of the blocking portion 212B of the belt of flexible material 212 over the opening in the cavity 134. The positioning of the blocker 210 to unblock the opening of the cavity 134 includes positioning of the open portion 212A of the belt of flexible material 212 over the opening in the cavity 134.

In accordance with yet another alternative non-limiting embodiment, not shown, the blocker 210 may be reconfigured, wherein the belt of flexible material 212 is provided as a more or less continuous sheet of material without an open portion 212A pre-defined therein. In addition, the core member 142 and the cavity member 132 are configured to cooperate, in use, to cause a punching (i.e. severing) of a segment of the belt of flexible material 212 with closing relative movement thereof. As such, with closing relative movement between the cavity member 132 and the core member 142 a portion of the belt of flexible material 212 is stretched up and into the cavity 134 by the core member 142. It is therefore contemplated that the punched segment of the belt of material 212 is arranged in the molding cavity 101 for integration into the molded article 102. The belt of material 212 may comprise a stretchable film such as, for example, a label or a barrier film (i.e. a barrier to gas exchange).

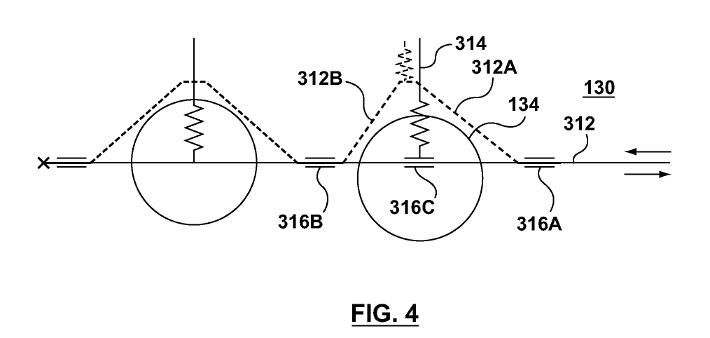

With reference to FIG. 4 there is depicted yet another non-limiting embodiment of a blocker 310 for use in the mold 100. The blocker 310 comprises one or more cables 312 that are positionable to block and unblock the opening of the cavity 134 with a tightening (i.e. pulling the cable taut) and a loosening (allowing the cable to go slack) thereof, respectively. To provide for the foregoing, the cable 312 is passed through a set cable guides 316A, 316B, 316C, a pair of which (i.e. guide 316A and 316B) are affixed to a face of the first mold half 130 on either side of the cavity 134 and a third of which is attached to a free end of a spring 314 that is connected to the first mold half 130 beside the opening of the cavity 134. As shown in hidden line, with a loosening of the cable 312 segments 312A and 312B thereof are biased away from the opening of the cavity 134 by the spring 314. As shown in solid line, with a tightening of the cable the segments 312A and 312B thereof are brought into a line which crosses a diameter of the cavity 134.

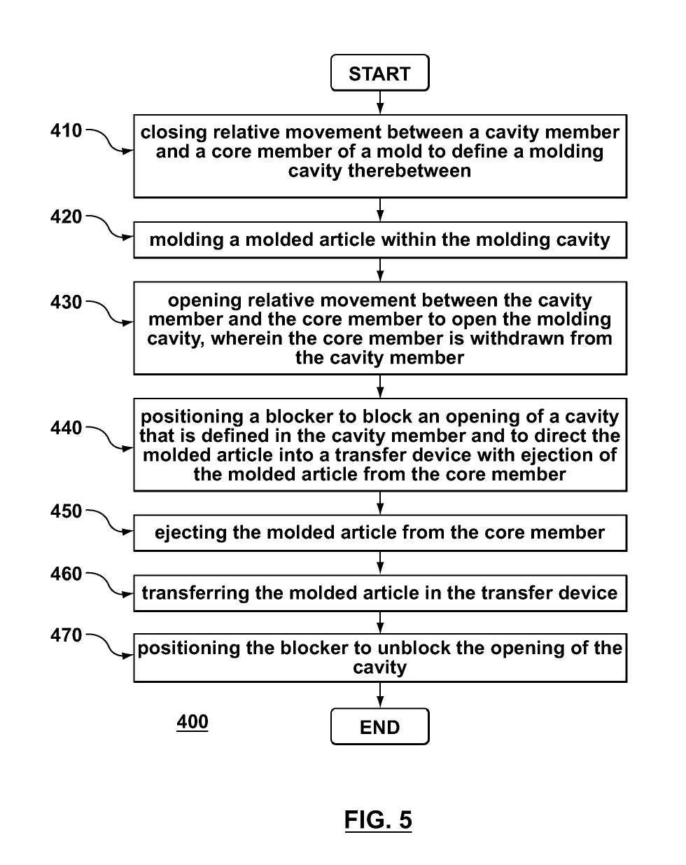

Having described various non-limiting embodiments of the mold 100 including the blocker 110, 210, 310 a non-limiting embodiment of a method of molding will now be briefly discussed with reference to the flow chart of FIG. 5. The method generally includes the steps of:

Step 410

With reference to FIG. 1A, the method begins with a closing relative movement between the cavity member 132 and the core member 142 of the mold 100 to define the molding cavity 101 therebetween. The closing relative movement may be provided by the in-mold shutter 160 as previously described or it may be done in a more traditional manner with relative movement of the first mold half 130 and the second mold half 140 by means of movement of platens (not shown) of the mold clamping assembly (not shown).

Step 420

The method next includes molding the molded article 102 within the molding cavity 101. The step of molding includes the sub-steps of injecting (i.e. fill and hold and part of cooling) molding material into the molding cavity 101 (FIG. 1A) to define the molded article therein.

Step 430

With reference to FIG. 1B, the method next includes opening relative movement between the cavity member 132 and the core member 142 to open the molding cavity 101, wherein the core member 142 is withdrawn from the cavity member 132. This step may also include, as previously described, positioning the molded article within the aperture 154A of the transfer device 150. Alternatively, the step may also include, upon opening of the mold, a positioning of a transfer device (not shown), such as an EOAT or an in-mold transfer device, both of which were described previously, into an inboard position for receiving the molded article.

Step 440

With reference to FIG. 1C, the method next includes positioning the blocker 110, 210, 310 to block an opening of the cavity 134 that is defined in the cavity member 132 for directing the molded article 102 into the transfer device 150 with ejection of the molded article 102 from the core member 142.

Step 450

With reference to FIG. 1D, the method next includes ejecting 450 the molded article 102 from the core member 142.

Step 460

With reference to FIG. 1E, the method next includes transferring 460 the molded article 102 in the transfer device 150.

Step 470

The method then repeats or ends with positioning 470 the blocker 110, 210, 310 to unblock the opening of the cavity 134.

It is noted that the foregoing has outlined some of the more pertinent non-limiting embodiments. It will be clear to those skilled in the art that modifications to the disclosed non-embodiment(s) can be effected without departing from the spirit and scope thereof. As such, the described non-limiting embodiment(s) ought to be considered to be merely illustrative of some of the more prominent features and applications. Other beneficial results can be realized by applying the non-limiting embodiments in a different manner or modifying the invention in ways known to those familiar with the art. This includes the mixing and matching of features, elements and/or functions between various non-limiting embodiment(s) is expressly contemplated herein so that one of ordinary skill in the art would appreciate from this disclosure that features, elements and/or functions of one embodiment may be incorporated into another embodiment as skill in the art would appreciate from this disclosure that features, elements and/or functions of one embodiment may be incorporated into another embodiment as appropriate, unless described otherwise, above. Although the description is made for particular arrangements and methods, the intent and concept thereof may be suitable and applicable to other arrangements and applications. cm What is claimed is:

1. An apparatus for use with a mold (100), comprising:
a blocker (110, 210, 310) that is configured to selectively block an opening of a cavity (134) defined in a cavity member (132) of the mold (100) after retraction of a core member (142) from the cavity (134), whereupon with ejection of a molded article (102) from the core member (142) the molded article (102) is directed by the blocker (110, 210, 310) into a transfer device (150) for transfer from the mold (100).

2. The apparatus of claim 1, wherein:
the blocker (110, 210, 310) is selectively positionable in between the cavity member (132) and a receptacle (154) of the transfer device (150) upon retraction of the core member (142) from the cavity (134);
wherein the blocker (110, 210, 310) blocks the opening of the cavity (134) to ensure that the molded article (102) is directed into the receptacle (154) with the ejection thereof from the core member (142) without re-entering the cavity (134).

3. The apparatus of claim 2, wherein:
the receptacle (154) includes an aperture (154A) that is defined in a shuttle (152) of the transfer device (150), wherein the aperture (154A) is configured to alternately receive: i) the core member (142) positioned therein during molding of the molded article (102); and ii) the molded article (102) received therein after the ejection thereof from the core member (142);
wherein the blocker (110, 210, 310) directs the molded article (102A) into the aperture (154) with the ejection of the molded article (102) from the core member (142);
the molded article (102) being transferrable within the aperture (154A) with sliding movement of the shuttle (154).

4. The apparatus of claim 3, wherein:
the receptacle (154) is partly defined the blocker (110, 210, 310).

5. The apparatus of claim 4, wherein:
the blocker (110, 210, 310) is movable with the shuttle (152) from a receiving position (R) to a transfer position (T) so as to continue to define a portion of the receptacle (154) throughout a movement therebetween.

6. The apparatus of claim 1, wherein:
the blocker (310) is positionable to partly cover the opening of the cavity (134).

7. The apparatus of claim 1, wherein:
the blocker (110, 210) is positionable to entirely cover the opening of the cavity (134).

8. The apparatus of claim 1, wherein:
the blocker (110) is a blade (112) that is slidable over the opening of the cavity (134), wherein the blade (112) defines an open portion (112A) and a blocking portion (112B) that are alternately positionable over the opening in the cavity (134).

9. The apparatus of claim 1, wherein:
the blocker (210) is a belt of flexible material (212) that is selectively positionable over the opening of the cavity (134).

10. The apparatus of claim 9 wherein:
the belt of flexible material (212) defines an open portion (212A) and a blocking portion (212B) that are alternately positionable over the opening in the cavity (134).

11. The apparatus of claim 9, wherein:
the core member (142) and the cavity member (132) are configured to cooperate in punching a segment of the belt of flexible material (212) with closing relative movement thereof.

12. The apparatus of claim 11, wherein:
the segment of the belt of flexible material (212) is integrated into the molded article (102).

13. The apparatus of claim 1, wherein:
the blocker (110, 210, 310) is a cable (312) that is biased away from the opening in the cavity (134) when made slack and that is positioned over the opening in the cavity (134) when made taut.

14. A method (400) of molding, comprising:
closing (410) relative movement between a cavity member (132) and a core member (142) of a mold (100) to define a molding cavity (101) therebetween;
molding (420) a molded article (102) within the molding cavity (101);
opening (430) relative movement between the cavity member (132) and the core member (142) to open the molding cavity (101), wherein the core member (142) is withdrawn from the cavity member (132);
positioning (440) a blocker (110, 210, 310) to block the opening of a cavity (134) that is defined in the cavity member (132) for directing the molded article (102) into a transfer device (150) with ejection of the molded article (102) from the core member (142);
ejecting (450) the molded article (102) from the core member (142);
transferring (460) the molded article (102) in the transfer device (150);
positioning (470) the blocker (110, 210, 310) to unblock the opening of the cavity (134).

15. The method (400) of claim 14, wherein:
the positioning of the blocker (110, 210, 310) to block the opening of the cavity (134) includes positioning the blocker (110, 210, 310) in between the cavity member (132) and a receptacle (154) of a transfer device (150) upon retraction of the core member (142) from the cavity (134);
wherein the blocker (110, 210, 310) blocks the opening of the cavity (134) to ensure that the molded article (102) is directed into the receptacle (154) with the ejection thereof from the core member (142) without re-entering the cavity (134).

16. The method (400) of claim 14, wherein:
the positioning of the blocker (210) to block the opening of the cavity (134) includes positioning of a blocking portion (212B) of a blade (212) over the opening in the cavity (134);
the positioning of the blocker (210) to unblock the opening of the cavity (134) includes positioning of an open portion (212A) of the blade (212) over the opening in the cavity (134).

17. The method (400) of claim 14, wherein:
the positioning of the blocker (210) to block the opening of the cavity (134) includes positioning of a blocking portion (212B) of a belt of flexible material (212) over the opening in the cavity (134);
the positioning of the blocker (210) to unblock the opening of the cavity (134) includes positioning of an open portion (212A) of the belt of flexible material (212) over the opening in the cavity (134).

18. The method (400) of claim 14, wherein:
the positioning of the blocker (210) to block the opening of the cavity (134) includes positioning of a belt of flexible material (212) over the opening in the cavity (134);
the closing relative movement between the cavity member (132) and the core member (142) causes a punching of a segment of the belt of flexible material (212) from the blocker (210), wherein the segment is arranged in the molding cavity (101) for integration into the molded article (102).

19. The method (400) of claim 14, wherein:
the positioning of the blocker (310) to block the opening of the cavity (134) includes tightening a cable (312) thereof to position it over the opening in the cavity (134);
the positioning of the blocker (310) to unblock the opening of the cavity (134) includes loosening the cable (312) such that it may be biased away from the opening in the cavity (134).
